(19) United States
(12) Patent Application Publication
(10) Pub. No.: US 2025/0251995 A1
(43) Pub. Date: Aug. 7, 2025

(54) CONFIGURABLE API CONNECTOR

(71) Applicant: INTUIT INC., Mountain View, CA (US)

(72) Inventors: Rohit KUMAR, Bangalore (IN); Nishant SEHGAL, Bangalore (IN); Purushottam SINHA, Bangalore (IN); Aditi AGGARWAL, Bangalore (IN); Raghav AGARWAL, Bangalore (IN)

(73) Assignee: INTUIT INC., Mountain View, CA (US)

(21) Appl. No.: 18/435,975

(22) Filed: Feb. 7, 2024

(51) Int. Cl. G06F 9/54

(52) U.S. Cl. CPC G06F 9/541

(57) ABSTRACT

Systems and methods are provided implementing a configurable API connector.

### BACKGROUND OF THE DISCLOSURE

Generally, it can be desirable for frameworks used to develop web applications and microservices to be open-source and operate at an enterprise level. Such a framework is commonly used to create standalone, production-grade applications. Once these applications are created, they generally will need to make application programming interface (API) requests to downstream services to request data. To request this data, the framework used to create the application uses a set of structured rules for the exchange of data (i.e., via the API, typically either a representational state transfer (REST) or GraphQL). However, the applications created via the framework utilize their own REST and GraphQL clients and manage their configurations (e.g., connection pool, http client configurations, etc.) on their own. This is cumbersome and undesirable as it can create challenges in the path of rapid development where each framework service is performing the same exercise to make REST and GraphQL calls.

### BRIEF DESCRIPTION OF THE FIGURES

FIG. 1 is a block diagram of an example system for implementing a configurable API connector according to example embodiments of the present disclosure.

FIG. 2 is a flowchart of an example process for utilizing a configurable API connector according to example embodiments of the present disclosure.

FIG. 3 is an example REST API curl request according to an embodiment of the present disclosure.

FIG. 4 is an example GraphQL API request according to an embodiment of the present disclosure.

FIG. 5 is an example extension of the configurable API connector according to an embodiment of the present disclosure.

FIG. 6 is an example REST API curl request with a configuration for the configurable API connector according to an embodiment of the present disclosure.

FIG. 7 is an example GraphQL request with a configuration for the configurable API connector according to an embodiment of the present disclosure.

FIG. 8 is server device that can be used within the system of FIG. 1 according to an embodiment of the present disclosure.

FIG. 9 is an example computing device that can be used within the system of FIG. 1 according to an embodiment of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the present disclosure relate to a configurable API connector that can make API requests in multiple query languages, such as Rest or GraphQL. The disclosed connector can be utilized in conjunction with a definition of an API request that a developer may create. In the disclosed system, a developer or other operator can define a configuration for payload and responses in a request definition, and the disclosed connector can automatically construct the payload as defined by the configuration. The connector can therefore be used to make API requests without writing or managing several clients in any framework for developing web applications and microservices, such as a Spring Boot service.

For example, it may be desirable in some circumstances to make numerous different API requests for an application. To solve this problem, the disclosed connector can be imported as a dependency in the project within the framework service. Various configurations and parameters are defined (e.g., by the developer). In accordance with the disclosed principles, whenever an API request is needed, the request can include a call to execute the connector along with potential configurations, which will automatically create the necessary API requests.

The disclosed connector provides various technical benefits, such as automating the payload construction and variable resolution and eliminating the declaration and management of multiple restTemplate and GraphQL clients, thereby conserving computational expenditures. Moreover, the disclosed connector is an organized, easier (by virtue of utilizing smaller amounts of code), and efficient way of orchestrating different API calls.

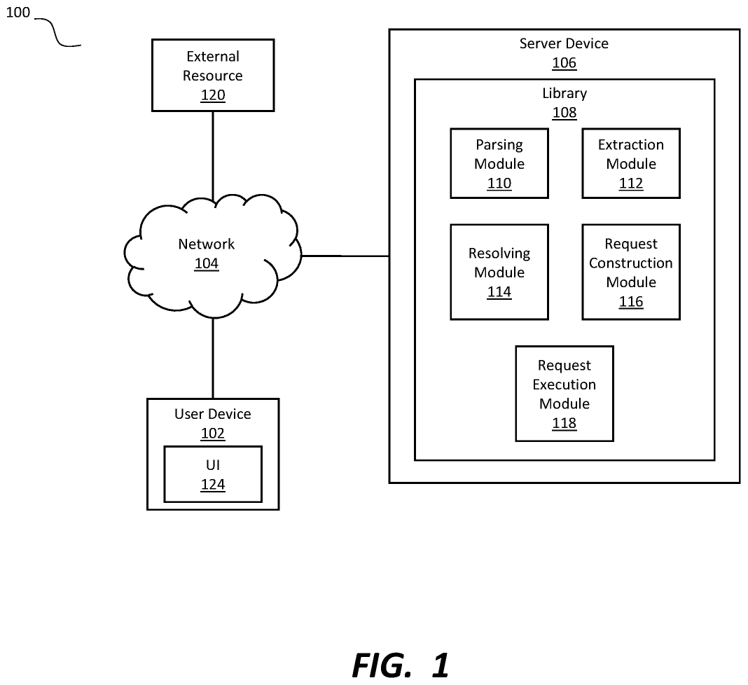

FIG. 1 is a block diagram of an example system 100 for implementing a configurable API connector according to example embodiments of the present disclosure. The system 100 can include one or more user devices 102 (generally referred to herein as a “user device 102” or collectively referred to herein as “user devices 102”) that can access, via network 104, a connector library 108 residing on a server device 106. This communication link enables a user (e.g., a developer) operating the user device 102 to utilize a user interface (UI) 124 to employ the library 108 during application development. In addition, the system 100 includes one or more external resources 120 (generally referred to herein as an “external resource 120” or collectively referred to herein as “external resources 120”). The external resources 120 can be various downstream services that data may be obtained from for the application that is being created or while the application operates after its creation and deployment.

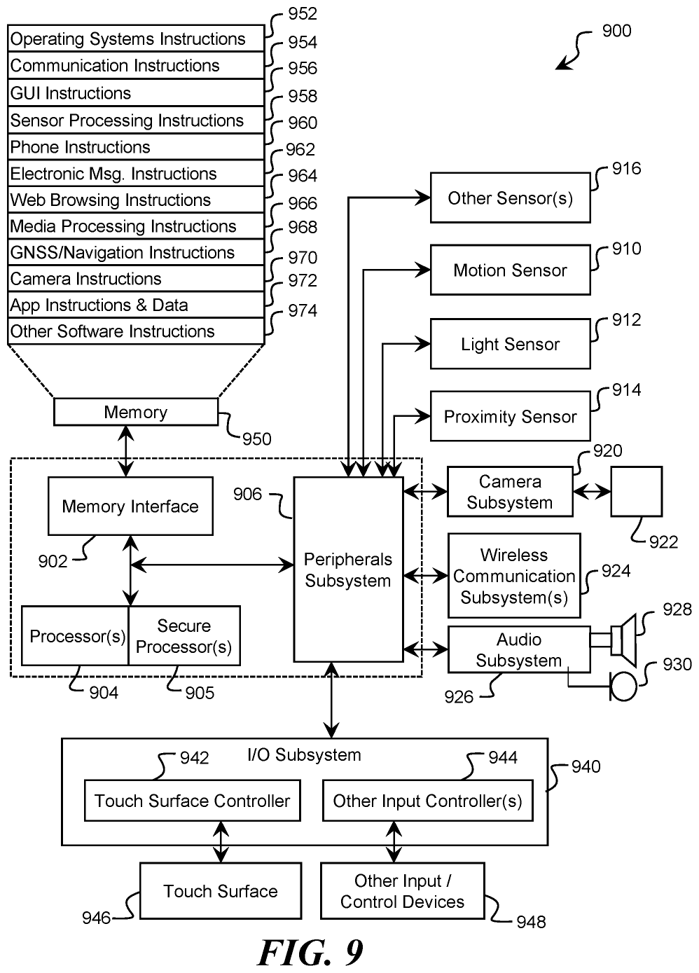

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, tablet, or other suitable device. In some embodiments, a user device 102 can be the same as or similar to the computing device 900 described below with respect to FIG. 9.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

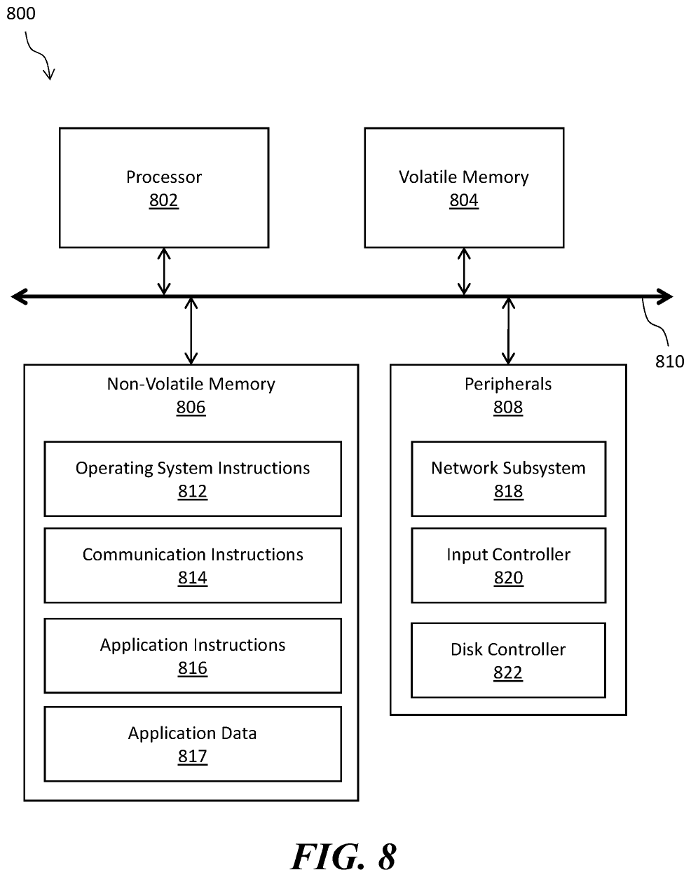

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure. In some embodiments, the server 106 may be the same as or similar to server 800 described below in the context of FIG. 8.

As shown in FIG. 1, the server device 106 includes the connector library 108, which a user via user device 102 can invoke during application development to utilize the disclosed configurable connector. The connector library 108 can include a parsing module 110, an extraction module 112, a resolving module 114, a request construction module 116, and a request execution module 118.

When a developer, via the user device 102, is creating an application, they can provide an initial request definition to the server 106 over the network 104. The request definition can include the connector class and various input parameters, such as the URL where the data will be obtained from, an http method type, a request type, body parameters, etc. In some embodiments, the body parameters can be used when clients send data to the API. Generally, parameters can be shipped in a JSON object in POST, PUT, or PATCH requests. In some embodiments, the parsing module 110 is configured to parse the received request definition. For example, the parsing module 110 can parse the request definition to identify the connector configuration and input parameters. In addition, the parsing module 110 can validate the parsed values.

In some embodiments, the extraction module 112 is configured to extract the body parameters from the request definition, which can eventually be used to construct the API requests. In some embodiments, the resolving module 114 is configured to resolve the extracted parameters. For example, the resolving module 114 can resolve the parameters in a recursive fashion and substitute their values based on the provided connector configuration.

In some embodiments, the request construction module 116 is configured to generate request headers based on the provided connector configuration. For example, the request construction module 116 can identify the type of API request based on the connector configuration, such as a REST API request or a GraphQL request, although the disclosed embodiments are not limited to these. In some embodiments, the request construction module 116 is configured to construct the API request object based on the connector configuration.

In some embodiments, the request execution module 118 can include a Spring web client, which can include a reactive HTTP library that serves as a follow up to the traditional REST template in maintenance mode. In some embodiments, Spring web clients can execute both REST and GraphQL requests in Java, as well as offer reactive asynchronous properties to requests.

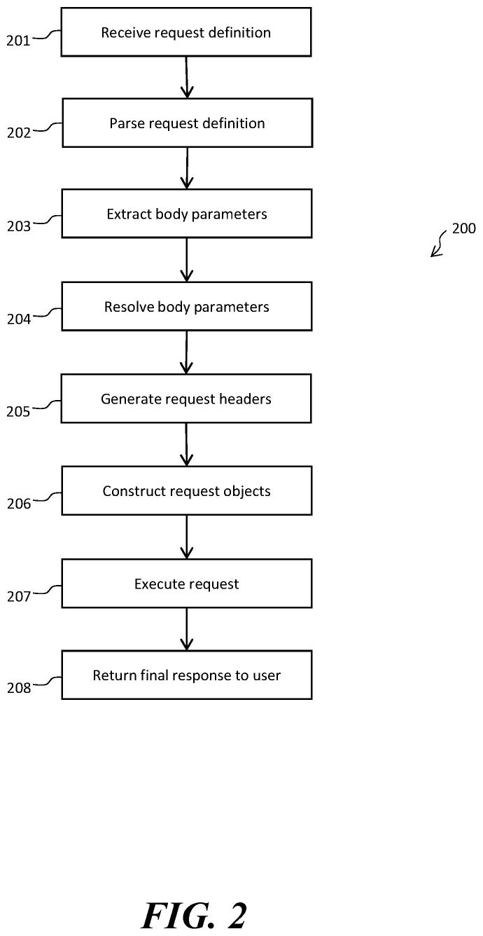

FIG. 2 is a flowchart of an example process 200 for utilizing a configurable API connector according to example embodiments of the present disclosure. In some embodiments, process 200 can be performed by the server 106 in conjunction with an ongoing communication between a user device 102 and the connector library 108. For example, a user may be developing an application and utilizing the connector library to enable configurable and automatically generated API requests consistent with the embodiments disclosed herein. The user may wish to develop an application that requests data from various downstream services, such as the external resources 120, that may require different types of API requests. The process 200 enables the application to perform as such without writing or managing separate web clients for each type of API request.

At block 201, the server 106 receives a request definition from a user device 102. In some embodiments, the request definition can be used to define the information necessary for the disclosed connector to generate a corresponding API request. The request definition can include a connector class (also referred to herein as a connector configuration) and various body parameters, such as a URL to obtain data from (i.e., associated with an external resource 120), an http method type, a request type, and other body parameters. In some embodiments, block 201 can be performed during development and setup of the initial application. In some embodiments, the parameters can be provided in an unstructured format or with either primitive or complex data types (e.g., lists, maps, etc.). In some embodiments, the request definition can also include a customized retry handler. A customized retry handler can be invoked after exhaustion of all retries specific in a standard configuration. For example, the customized retry handler can specify a maximum number of attempts to execute the API request and obtain the data from the downstream external resource 120 and a time with which to backoff between retries.

At block 202, the parsing module 110 parses the request definition. In some embodiments, the parsing module 110 can parse the request definition to identify the connector configuration and body or other input parameters (generally referred to herein as “API parameters”). In some embodiments, the parsing module 110 can validate the parsed values. For example, if any headers and request body parameters provided by the user in the configuration and execution request are invalid, then an exception can be thrown to the user flagging the appropriate error cause. At block 203, the extraction module 112 extracts body parameters from the request definition, which can be used to construct the desired API requests. At block 204, the resolving module 114 resolves the parameters after they are extracted. For example, the resolving module 114 can resolve the parameters in a recursive fashion and substitute their values based on the provided connector configuration.

At block 205, the request construction module 116 generates request headers based on the provided connector configuration. For example, the request construction module 116 can identify the type of API request based on the connector configuration, such as a REST API request or a GraphQL request, although the disclosed embodiments are not limited to these. In some embodiments, the request construction module 116 is configured to construct the API request object based on the connector configuration. At block 206, the request construction module 116 constructs the request objects based on the provided connector configuration. For example, if the configuration defines the class as REST, then the request construction module 116 constructs a REST API request. In another example, if the configuration defines the class as GraphQL, then the request construction module 116 constructs a GraphQL API request.

At block 207, the API request is executed. In some embodiments, the request can be executed using a Spring5 web client, which can also make asynchronous requests as needed. In some embodiments, the web client can also be customized by the server 106 for a user based on the provided connector configuration. If the provided connector configuration does not contain information with which a web client can be customized, a default one can be used. In some embodiments, the URL can be parsed by the parsing module 110 based on an environment received in the request definition. In some embodiments, when an API request is executed, the relevant data is obtained from the downstream external resource 120 for use within the application. At block 208, a final response based on the executed API request is returned to the user of the application. For example, the final response can be displayed on the user interface 124 of the user device 102. In some embodiments, the user device 102 can be the same device that developed the application (e.g., during testing). In other embodiments, the final response may be returned to be displayed on a different user device 102. In some embodiments, if there is an error during the execution of the API request at block 208 (e.g., the data is unable to be obtained or the external resource 120 is at capacity with other requests), the server 106 (e.g., via one or more Spring 5 web clients) can execute a retry (i.e., a “retry execution”) based on the received customized retry handler.

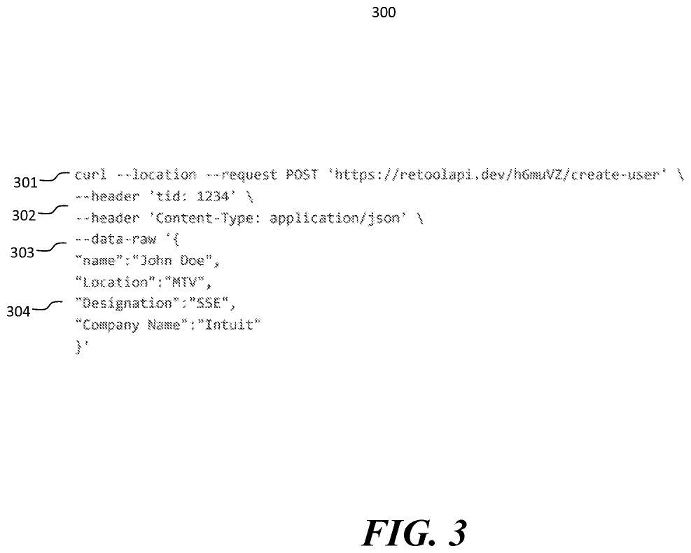

FIG. 3 is an example REST API curl request 300 according to an embodiment of the present disclosure. The request 300 includes an entry 301 specifying the URL from which data will be obtained, header information 302, the type of data to be obtained from the data source 303, and body parameters 304.

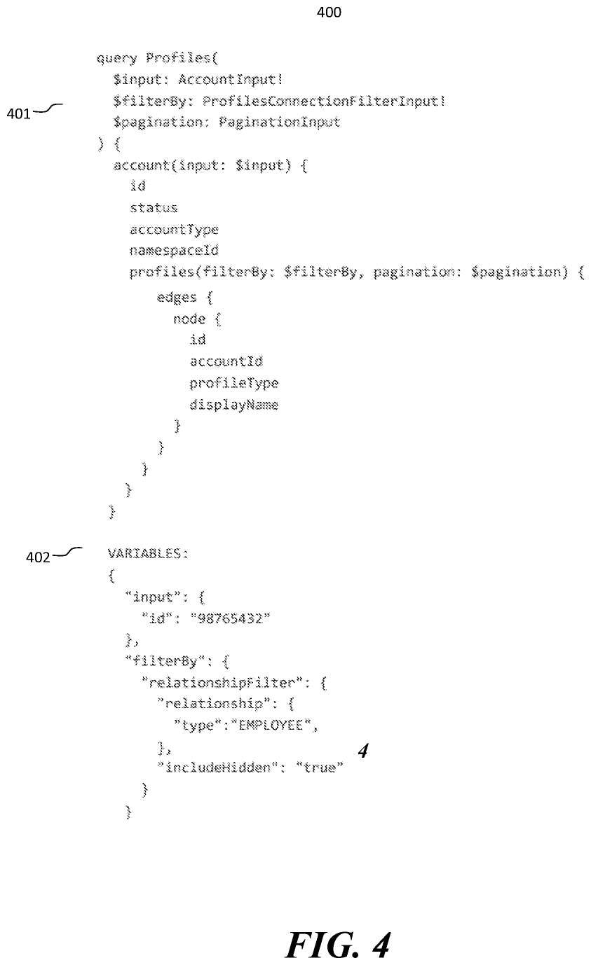

FIG. 4 is an example GraphQL API request 400 according to an embodiment of the present disclosure. The request includes a query profile 401 and a variable specification 402.

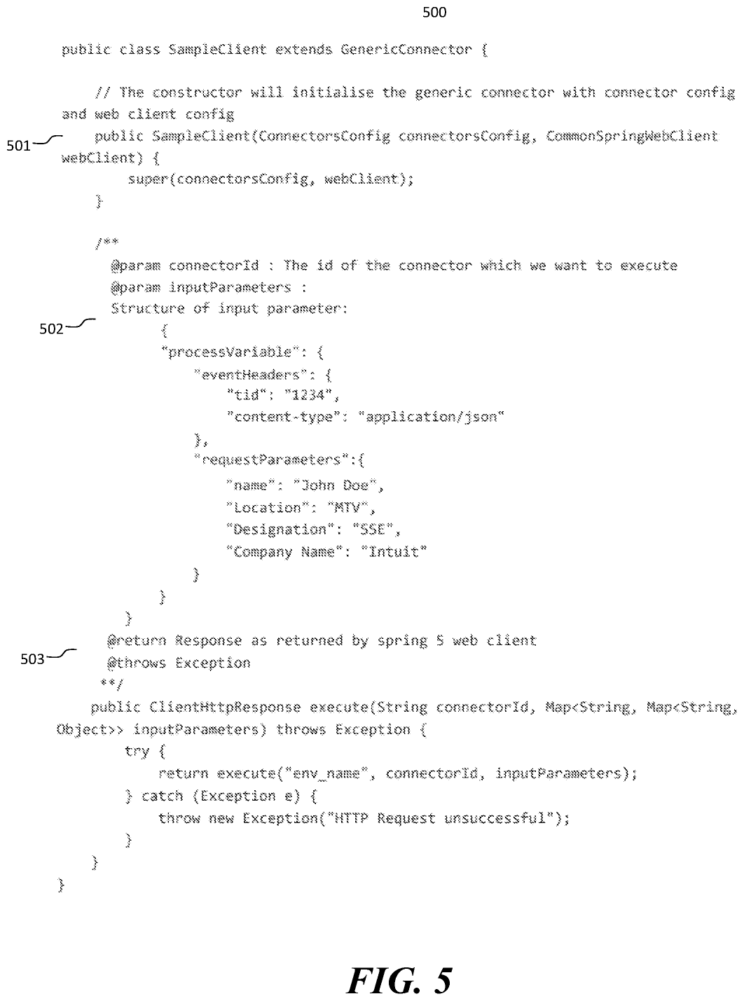

FIG. 5 is an example extension 500 of the configurable API connector according to an embodiment of the present disclosure. The extension 500 includes a call 501 of the various functions from the connector library 108, an input parameter structure 502, and instructions 503 for returning the response after data has been obtained from an upstream service.

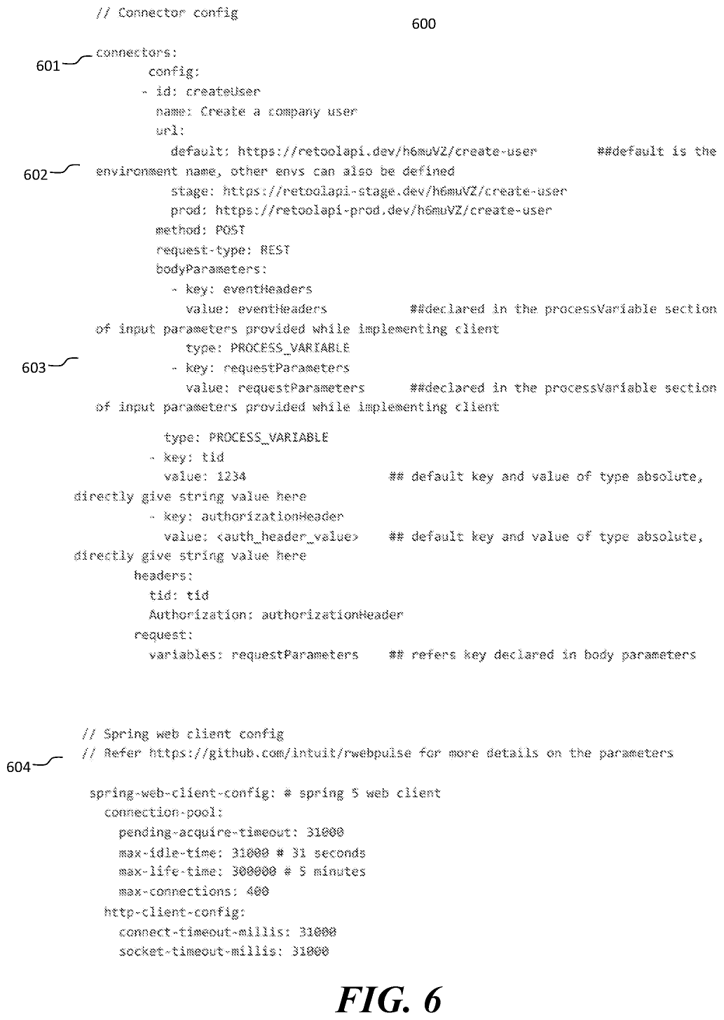

FIG. 6 is an example REST API curl request 600 with a configuration for the configurable API connector according to an embodiment of the present disclosure. The request 600 includes a connector configuration 601, an environment definition 602, an input parameter structure 603, and instructions 604 for executing the request on, for example, a Spring web client.

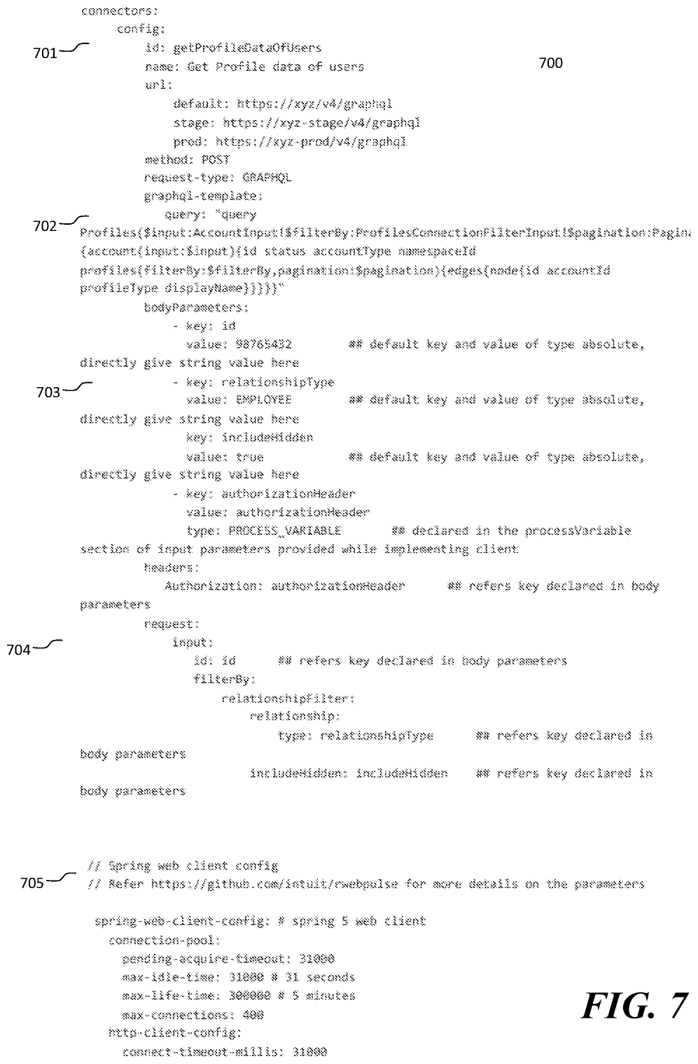

FIG. 7 is an example GraphQL request 700 with a configuration for the configurable API connector according to an embodiment of the present disclosure. The request 700 includes a connector configuration 701, a profile definition section 702, body parameters 703, input parameter structure 704, and instructions 705 for executing the request on, for example, a Spring web client.

FIG. 8 is a diagram of an example server device 800 that can be used within system 100 of FIG. 1. Server device 800 can implement various features and processes as described herein. Server device 800 can be implemented on any electronic device that runs software applications derived from complied instructions, including without limitation personal computers, servers, smart phones, media players, electronic tablets, game consoles, email devices, etc. In some implementations, server device 800 can include one or more processors 802, volatile memory 804, non-volatile memory 806, and one or more peripherals 808. These components can be interconnected by one or more computer buses 810.

Processor(s) 802 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 810 can be any known internal or external bus technology, including but not limited to ISA, EISA, PCI, PCI Express, USB, Serial ATA, or FireWire. Volatile memory 804 can include, for example, SDRAM. Processor 802 can receive instructions and data from a read-only memory or a random access memory or both. Essential elements of a computer can include a processor for executing instructions and one or more memories for storing instructions and data.

Non-volatile memory 806 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 806 can store various computer instructions including operating system instructions 812, communication instructions 814, application instructions 816, and application data 817. Operating system instructions 812 can include instructions for implementing an operating system (e.g., Mac OS®, Windows®, or Linux). The operating system can be multi-user, multiprocessing, multitasking, multithreading, real-time, and the like. Communication instructions 814 can include network communications instructions, for example, software for implementing communication protocols, such as TCP/IP, HTTP, Ethernet, telephony, etc. Application instructions 816 can include instructions for various applications. Application data 817 can include data corresponding to the applications.

Peripherals 808 can be included within server device 800 or operatively coupled to communicate with server device 800. Peripherals 808 can include, for example, network subsystem 818, input controller 820, and disk controller 822. Network subsystem 818 can include, for example, an Ethernet of WiFi adapter. Input controller 820 can be any known input device technology, including but not limited to a keyboard (including a virtual keyboard), mouse, track ball, and touch-sensitive pad or display. Disk controller 822 can include one or more mass storage devices for storing data files; such devices include magnetic disks, such as internal hard disks and removable disks; magneto-optical disks; and optical disks.

FIG. 9 is an example computing device that can be used within the system 100 of FIG. 1, according to an embodiment of the present disclosure. In some embodiments, device 900 can be user device 102. The illustrative user device 900 can include a memory interface 902, one or more data processors, image processors, central processing units 904, and or secure processing units 905, and peripherals subsystem 906. Memory interface 902, one or more central processing units 904 and or secure processing units 905, and or peripherals subsystem 906 can be separate components or can be integrated in one or more integrated circuits. The various components in user device 900 can be coupled by one or more communication buses or signal lines.

Sensors, devices, and subsystems can be coupled to peripherals subsystem 906 to facilitate multiple functionalities. For example, motion sensor 910, light sensor 912, and proximity sensor 914 can be coupled to peripherals subsystem 906 to facilitate orientation, lighting, and proximity functions. Other sensors 916 can also be connected to peripherals subsystem 906, such as a global navigation satellite system (GNSS) (e.g., GPS receiver), a temperature sensor, a biometric sensor, magnetometer, or other sensing device, to facilitate related functionalities.

Camera subsystem 920 and optical sensor 922, e.g., a charged coupled device (CCD) or a complementary metal-oxide semiconductor (CMOS) optical sensor, can be utilized to facilitate camera functions, such as recording photographs and video clips. Camera subsystem 920 and optical sensor 922 can be used to collect images of a user to be used during authentication of a user, e.g., by performing facial recognition analysis.

Communication functions can be facilitated through one or more wired and or wireless communication subsystems 924, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 924. The specific design and implementation of communication subsystems 924 can depend on the communication network(s) over which the user device 900 is intended to operate. For example, user device 900 can include communication subsystems 924 designed to operate over a GSM network, a GPRS network, an EDGE network, a WiFi or WiMax network, and a Bluetooth™ network. For example, wireless communication subsystems 924 can include hosting protocols such that device 900 can be configured as a base station for other wireless devices and or to provide a WiFi service.

Audio subsystem 926 can be coupled to speaker 928 and microphone 930 to facilitate voice-enabled functions, such as speaker recognition, voice replication, digital recording, and telephony functions. Audio subsystem 926 can be configured to facilitate processing voice commands, voice-printing, and voice authentication, for example.

I/O subsystem 940 can include a touch-surface controller 942 and or other input controller(s) 944. Touch-surface controller 942 can be coupled to a touch-surface 946. Touch-surface 946 and touch-surface controller 942 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 946.

The other input controller(s) 944 can be coupled to other input/control devices 948, such as one or more buttons, rocker switches, thumb-wheel, infrared port, USB port, and or a pointer device such as a stylus. The one or more buttons (not shown) can include an up/down button for volume control of speaker 928 and or microphone 930.

In some implementations, a pressing of the button for a first duration can disengage a lock of touch-surface 946; and a pressing of the button for a second duration that is longer than the first duration can turn power to user device 900 on or off. Pressing the button for a third duration can activate a voice control, or voice command, module that enables the user to speak commands into microphone 930 to cause the device to execute the spoken command. The user can customize a functionality of one or more of the buttons. Touch-surface 946 can, for example, also be used to implement virtual or soft buttons and or a keyboard.

In some implementations, user device 900 can present recorded audio and or video files, such as MP3, AAC, and MPEG files. In some implementations, user device 900 can include the functionality of an MP3 player, such as an iPod™. User device 900 can, therefore, include a 36-pin connector and or 8-pin connector that is compatible with the iPod. Other input/output and control devices can also be used.

Memory interface 902 can be coupled to memory 950. Memory 950 can include high-speed random access memory and or non-volatile memory, such as one or more magnetic disk storage devices, one or more optical storage devices, and or flash memory (e.g., NAND, NOR). Memory 950 can store an operating system 952, such as Darwin, RTXC, LINUX, UNIX, OS X, Windows, or an embedded operating system such as VxWorks.

Operating system 952 can include instructions for handling basic system services and for performing hardware dependent tasks. In some implementations, operating system 952 can be a kernel (e.g., UNIX kernel). In some implementations, operating system 952 can include instructions for performing voice authentication.

Memory 950 can also store communication instructions 954 to facilitate communicating with one or more additional devices, one or more computers and or one or more servers. Memory 950 can include graphical user interface instructions 956 to facilitate graphic user interface processing; sensor processing instructions 958 to facilitate sensor-related processing and functions; phone instructions 960 to facilitate phone-related processes and functions; electronic messaging instructions 962 to facilitate electronic messaging-related process and functions; web browsing instructions 964 to facilitate web browsing-related processes and functions; media processing instructions 966 to facilitate media processing-related functions and processes; GNSS/Navigation instructions 968 to facilitate GNSS and navigation-related processes and instructions; and or camera instructions 970 to facilitate camera-related processes and functions.

Memory 950 can store application (or “app”) instructions and data 972, such as instructions for the apps described above in the context of FIGS. 1-7. Memory 950 can also store other software instructions 974 for various other software applications in place on device 900. The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A computing system comprising:
a processor; and
a non-transitory computer-readable storage device storing computer-executable instructions, the instructions operable to cause the processor to perform operations comprising:
parsing a request definition for an application programming interface (API) request, the request definition comprising a connector configuration and one or more API parameters;
extracting the one or more API parameters from the request definition;
resolving the extracted one or more API parameters;
generating a request header based on the connector configuration;
posting the request header;
constructing the API request based on the connector configuration; and
executing the API request.

2. The computing system of claim 1, wherein resolving the extracted one or more API parameters comprises:
resolving the extracted one or more API parameters in a recursive fashion; and
substituting each extracted value based on the connector configuration.

3. The computing system of claim 1, wherein the operations further comprise validating the extracted one or more API parameters.

4. The computing system of claim 1, wherein resolving the extracted one or more API parameters comprises identifying an API type associated with the API request from the request definition.

5. The computing system of claim 4, wherein constructing the API request comprises constructing the API request with the identified API type.

6. The computing system of claim 4, wherein identifying the API type associated with the API request comprises identifying a representational state transfer (REST) type or a GraphQL type.

7. The computing system of claim 1, wherein executing the API request comprises executing the API request with one or more Spring web clients.

8. The computing system of claim 1, wherein the operations further comprise returning a final response from the API request to a user device.

9. The computing system of claim 1, wherein parsing the request definition for the API request comprises identifying a customized retry handler.

10. The computing system of claim 9, wherein the operations further comprise executing a retry execution based on the customized retry handler.

11. A computer-implemented method, performed by at least one processor, comprising:
parsing a request definition for an application programming interface (API) request, the request definition comprising a connector configuration and one or more API parameters;
extracting the one or more API parameters from the request definition;
resolving the extracted one or more API parameters;
generating a request header based on the connector configuration;
posting the request header;
constructing the API request based on the connector configuration; and
executing the API request.

12. The computer-implemented method of claim 11, wherein resolving the extracted one or more API parameters comprises:
resolving the extracted one or more API parameters in a recursive fashion; and substituting each extracted value based on the connector configuration.

13. The computer-implemented method of claim 11 further comprising validating the extracted one or more API parameters.

14. The computer-implemented method of claim 11, wherein resolving the extracted one or more API parameters comprises identifying an API type associated with the API request from the request definition.

15. The computer-implemented method of claim 14, wherein constructing the API request comprises constructing the API request with the identified API type.

16. The computer-implemented method of claim 14, wherein identifying the API type associated with the API request comprises identifying a representational state transfer (REST) type or a GraphQL type.

17. The computer-implemented method of claim 11, wherein executing the API request comprises executing the API request with one or more Spring web clients.

18. The computer-implemented method of claim 11 further comprising returning a final response from the API request to a user device.

19. The computer-implemented method of claim 11, wherein parsing the request definition for the API request comprises identifying a customized retry handler.

20. The computer-implemented method of claim 19 further comprising executing a retry execution based on the customized retry handler.
